(19) United States
(12) Patent Application Publication
(10) Pub. No.: US 2018/0119715 A1
(43) Pub. Date: May 3, 2018

(54) SCREW GROMMET ATTACHMENT STRUCTURE

(71) Applicant: TOYOTA JIDOSHA KABUSHIKI KAISHA, Toyota-shi (JP)

(72) Inventor: Tomohiro SAKURAI, Seto-shi (JP)

(73) Assignee: TOYOTA JIDOSHA KABUSHIKI KAISHA, Toyota-shi (JP)

(21) Appl. No.: 15/788,369

(22) Filed: Oct. 19, 2017

(30) Foreign Application Priority Data
Nov. 2, 2016 (JP) 2016-215175

(51) Int. Cl. F16B 5/02; F16B 13/12

(52) U.S. Cl. CPC F16B 5/0258; F16B 13/124

(57) ABSTRACT

A screw grommet is configured such that a rectangular cylindrical body is passed through an attachment hole of a door inner panel, and detent portions are configured to project to opposite sides to an axial center side of the body and to be displaceable toward the axial center side of the body and toward the opposite side to the axial center side of the body, so that the detent portions are locked to an edge portion side of the attachment hole. First parts in an edge portion of the attachment hole and second parts in the edge portion of the attachment hole are provided.

### INCORPORATION BY REFERENCE

The disclosure of Japanese Patent Application No. 2016-215175 filed on Nov. 2, 2016 including the specification, drawings and abstract is incorporated herein by reference in its entirety.

### BACKGROUND

### 1. Technical Field

The present disclosure relates to a screw grommet attachment structure.

### 2. Description of Related Art

Japanese Patent Application Publication No. 8-21421 (JP 8-21421 A) discloses a structure for attaching a grommet screw (a screw grommet) to an attachment hole of a panel member. The structure is briefly described below. That is, the attachment hole having a generally square shape is formed in the panel member in a penetrated manner, and the grommet screw is configured such that a sectional contour orthogonal to its axis is formed in a generally square shape and a detent portion is provided on its corner side. The grommet screw is inserted into the attachment hole to a position where the detent portion is caught on an edge portion on a back side of the attachment hole of the panel member, so that the grommet screw is attached to the attachment hole of the panel member.

### SUMMARY

In the meantime, when a member having the aforementioned attachment hole formed therein in a penetrated manner is a panel member made of fiber reinforced resin, it is difficult to form the attachment hole by press, and the attachment hole is formed with a drill, for example. However, in such a case, an edge is formed in an opening end portion of the attachment hole. When such an edge is formed in the opening end portion of the attachment hole, the detent portion is caught on the edge at the time of inserting the grommet screw into the attachment hole, which increases an insertion load. In the meantime, in a case where a diameter of the attachment hole is just increased, there is a possibility that the grommet screw inserted therein wobbles.

The present disclosure is to obtain a screw grommet attachment structure that is able to restrain an insertion resistance at the time when a screw grommet is inserted into an attachment hole, while restraining wobbling of the screw grommet.

A screw grommet attachment structure according to one aspect of the present disclosure includes a screw grommet, and a panel member made of fiber reinforced resin, wherein: the screw grommet is attached to an attachment hole of the panel member made of fiber reinforced resin; the screw grommet includes a rectangular cylindrical body configured to be passed through the attachment hole of the panel member and having a screw hole into which a screw is screwed, the screw hole being formed in an axial center of the body; the screw grommet includes a flange portion overhanging in a rib shape from one end of the body in an axis direction, the one end being on an inlet side of the screw hole, the flange portion being configured such that a circumferential part of the attachment hole of the panel member is placed on a surface side of the flange portion, the surface side being opposite to a surface around an inlet of the screw hole; detent portions are formed on an outer periphery side of the body such that the detent portions project to opposite sides to an axial center side of the body and are displaceable toward the axial center side of the body and toward the opposite sides to the axial center side of the body, so that the detent portions are locked to an edge portion side of the attachment hole of the panel member; an edge portion of the attachment hole of the panel member includes first parts formed at least partially along respective side parts on an outer periphery of the body except for parts to which the detent portions are locked, when viewed in a penetration direction of the attachment hole, the first parts being configured to prevent rotation of the body around an axis of the body; and the edge portion of the attachment hole of the panel member includes second parts provided so as to correspond to the parts to which the detent portions are locked, the second parts being formed by cutting the edge portion toward opposite sides to a center side of the attachment hole on the basis of respective extended lines of the first parts when viewed in the penetration direction of the attachment hole.

Note that, the wording “provided so as to correspond to the parts to which the detent portions are locked” includes a case where the second parts are just provided so as to correspond to the parts to which the detent portions are actually locked in an assembled state, and a case where the second parts are provided so as to correspond to the parts to which the detent portions are actually locked in an assembled state, and in addition to that, the second parts are also provided so as to correspond to parts to which the detent portions are not locked in the above assembled state, but the detent portions are to be assembled in other assembled states in which the screw grommet is assembled to the panel member by shifting a relative position of the screw grommet to the attachment hole of the panel member, when viewed in an assembling direction, by a predetermined angle around the axis from a relative position in the above assembled state.

In the above configuration, the rectangular cylindrical body of the screw grommet is passed through the attachment hole of the panel member made of fiber reinforced resin. The detent portions formed on the outer periphery side of the body project toward the opposite sides to the axial center side of the body and are displaceable toward the axial center side of the body and toward the opposite sides to the axial center side of the body, so that the detent portions are locked to an edge portion side of the attachment hole of the panel member.

Here, the edge portion of the attachment hole of the panel member includes the first parts at parts other than the parts to which the detent portions are locked. The first parts are formed at least partially along respective side parts on the outer periphery of the body when viewed in the penetration direction of the attachment hole, so as to prevent rotation of the body around its axis. On this account, it is possible to restrain wobbling of the screw grommet by the first parts. Further, the second parts are provided in the edge portion of the attachment hole of the panel member so as to correspond to the parts to which the detent portions are locked. The second parts are formed by cutting the edge portion toward the opposite sides to the center side of the attachment hole on the basis of respective extended lines of the first parts when viewed in the penetration direction of the attachment hole. On this account, at the time of assembling of the screw grommet to the panel member, it is possible to restrain an insertion resistance caused when the body of the screw grommet is inserted into the attachment hole of the panel member.

The screw grommet attachment structure may be configured such that: the detent portions are provided in respective intermediate parts of respective side parts on the outer periphery of the body when viewed in an axial direction of the screw grommet; the first parts are formed along entire regions of the respective side parts on the outer periphery of the body except for the respective intermediates parts when viewed in the penetration direction of the attachment hole; and the second parts are each provided between corresponding first parts placed in line so as to be distanced from each other when viewed in the penetration direction of the attachment hole, and connect respective ends of the corresponding first parts to each other in an arc shape.

With the above configuration, the first parts are formed along the entire regions of the respective side parts on the outer periphery of the body except for the respective intermediates parts when viewed in the penetration direction of the attachment hole, thereby making it possible to effectively restrain wobbling of the screw grommet by the first parts. Further, the second parts are each provided between corresponding first parts placed in line so as to be distanced from each other when viewed in the penetration direction of the attachment hole, and connect respective ends of the corresponding first parts to each other in an arc shape. When the second parts are formed in an arc shape rather than a shape in which one side of a rectangular shape is removed, for example, it is possible to accurately form the second parts in the panel member made of fiber reinforced resin with the use of a drill, for example.

As described above, the screw grommet attachment structure of one aspect of the present disclosure yields such an excellent effect that an insertion resistance at the time when the screw grommet is inserted into the attachment hole can be restrained while wobbling of the screw grommet is restrained.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an exploded perspective view illustrating a fastening structure including a screw grommet attachment structure according to one embodiment of the present disclosure;

FIG. 2A is a sectional view illustrating an unfinished state of insertion of a screw grommet into an attachment hole of a door inner panel;

FIG. 2B is a sectional view illustrating an assembled state where the screw grommet is inserted into the attachment hole of the door inner panel;

FIG. 3A is a bottom plan view illustrating a part of the door inner panel before the screw grommet is assembled;

FIG. 3B is a bottom plan view illustrating a state where the screw grommet is assembled to the attachment hole of the door inner panel;

FIG. 4 is a sectional view illustrating a state taken along a line 4-4 in FIG. 2B; and

FIG. 5 is a view illustrating the door inner panel including a part to which the screw grommet attachment structure is applicable, when viewed from a door inner side.

### DETAILED DESCRIPTION OF EMBODIMENTS

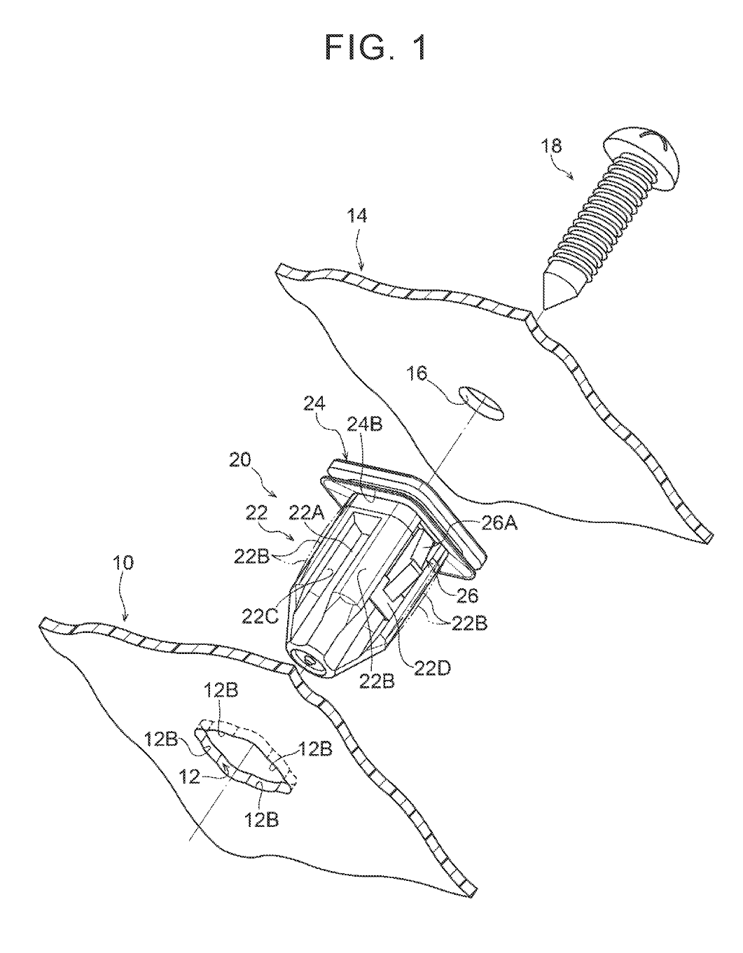

A screw grommet attachment structure according to one embodiment of the present disclosure is described with reference to FIGS. 1 to 5.

In FIG. 5, a door inner panel 10 as a panel member including a part to which the screw grommet attachment structure according to the present embodiment is applicable is illustrated in a state viewed from a door inner side. The door inner panel 10 constitutes an inner plate of a side door, and is made of fiber reinforced resin (carbon fiber reinforced resin in the present embodiment). Note that the fiber reinforced resin applied to the door inner panel 10 is carbon fiber reinforced resin in the present embodiment, but other fiber reinforced resins such as glass-fiber reinforced resin may be applied, for example. Attachment holes 12 for door trim fastening are formed in the door inner panel 10 in a penetrated manner. A door trim 14 (see FIG. 1) is an interior member made of resin and provided to line a surface of the door inner panel 10 on a compartment inner side.

FIG. 1 is an exploded perspective view of the screw grommet attachment structure for attaching a screw grommet 20 to the attachment hole 12 of the door inner panel 10 and a fastening structure including such a structure. As illustrated in FIG. 1, the door trim 14 has a screw insertion hole 16 formed in a penetrated manner so as to correspond to the attachment hole 12 of the door inner panel 10.

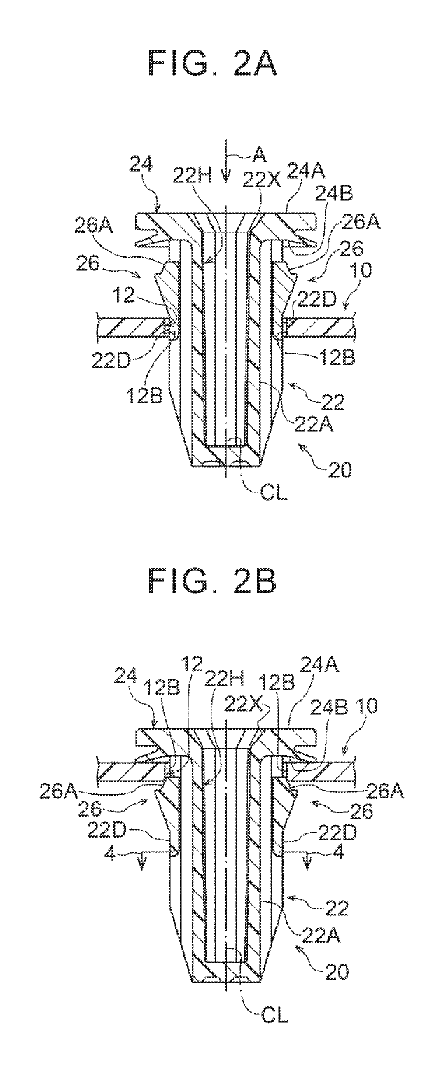

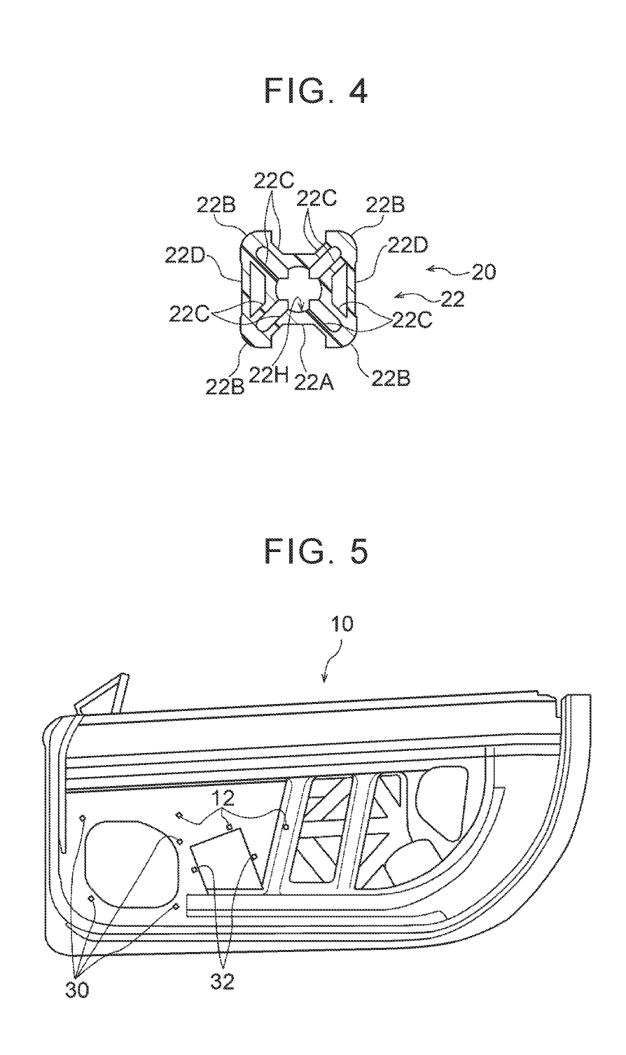

FIG. 2A is a sectional view of an unfinished state of insertion of the screw grommet 20 into the attachment hole 12 of the door inner panel 10, and an insertion direction of the screw grommet 20 is indicated by an arrow A. Further, FIG. 2B is a sectional view illustrating an assembled state where the screw grommet 20 is inserted into the attachment hole 12 of the door inner panel 10. Further, FIG. 4 illustrates a sectional view taken along a line 4-4 in FIG. 2B.

As illustrated in FIG. 2B, the screw grommet 20 includes a body 22 having a bottomed rectangular cylindrical shape (e.g., a bottomed squarely cylindrical shape in the present embodiment) so as to be passed through the attachment hole 12 of the door inner panel 10. Note that, in FIGS. 2A and 2B, an axial center line of the body 22 is indicated by an alternate long and short dash line CL. In an axial center of the body 22, a screw hole 22H into which a screw 18 (see FIG. 1, a tapping screw in the present embodiment) is screwed is formed. Further, a flange portion 24 overhangs in a rib shape from one end of the body 22 in an axis direction on an inlet-22X side of the screw hole 22H. A circumferential part of the attachment hole 12 of the door inner panel 10 is placed on a surface-24B side, which is an opposite side to a surface 24A around the inlet 22X of the screw hole 22H in the flange portion 24.

As illustrated in FIGS. 1 and 4, the body 22 includes an inner constituent part 22A constituting an inner side of the screw hole 22H (see FIG. 4), four corners 22B, in total, constituting four corners of the body 22 on an outer peripheral side, and first connection parts 22C that linearly connect the inner constituent part 22A to the corners 22B. The body 22 is configured such that, when the screw 18 (see FIG. 1) is screwed into the screw hole 22H (see FIG. 4), the inner constituent part 22A is pushed toward opposite sides to an axial center side of the body 22, and the corners 22B pressed by the inner constituent parts 22A via the first connection parts 22C are displaced to the opposite sides to the axial center side of the body 22. Note that, in FIG. 1, a state (i.e., a swelled state) where the corners 22B illustrated on right and left sides in the figure are displaced to the opposite sides to the axial center side of the body 22 is illustrated by an alternate long and two short dashes line.

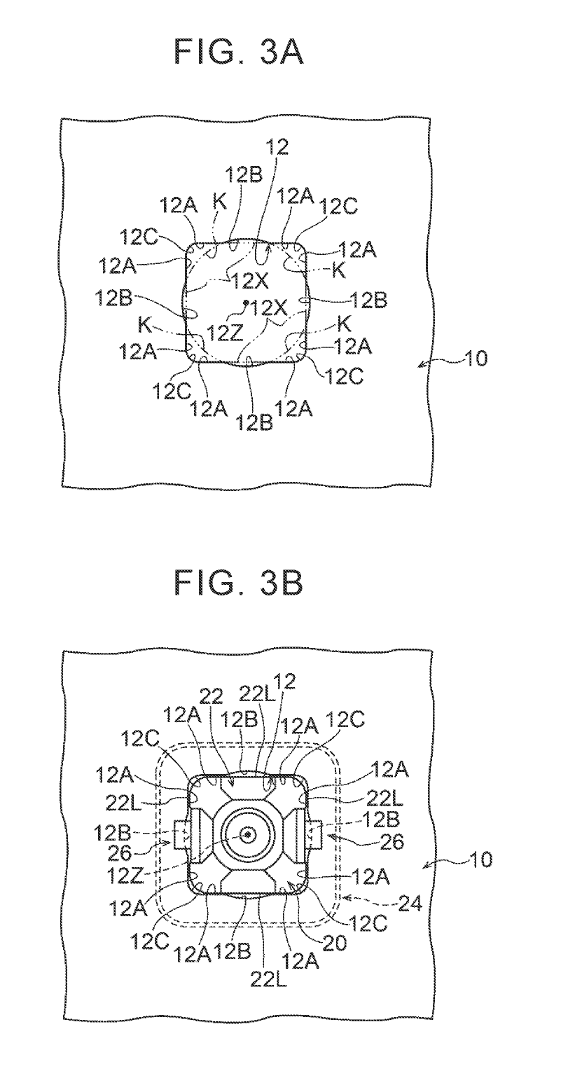

Further, a pair of second connection portions 22D that connect the corners 22B to each other are formed on outer periphery sides of corresponding intermediate parts of the body 22 in the axis direction. Respective detent portions 26 (see FIG. 1) are formed integrally in the second connection portions 22D. As illustrated in FIG. 1, the detent portion 26 extends toward the flange portion 24 from the second connection portion 22D side, on the outer periphery side of the body 22, and projects to an opposite side to the axial center side of the body 22. FIG. 3B is a bottom plan view illustrating a state where the screw grommet 20 is assembled to a part of the door inner panel 10. As illustrated in FIG. 3B, the detent portions 26 are provided in pair and are provided in respective intermediate parts of corresponding side parts 22L on the outer periphery of the body 22 when viewed in an axial direction of the screw grommet 20.

Further, as illustrated in FIG. 1, the detent portion 26 includes an inclined surface 26A inclined closer to the axial center side of the body 22 toward the flange portion 24 side. Both sides of the detent portion 26 are separated from the corners 22B and a top end thereof on the flange portion 24 side is separated from the flange portion 24, so that the detent portion 26 is displaceable toward the axial center side of the body 22 and its opposite side. As illustrated in FIG. 2B, the inclined surface 26A of the detent portion 26 is locked to an edge side of the attachment hole 12 of the door inner panel 10.

As illustrated in FIG. 3B, an edge portion of the attachment hole 12 of the door inner panel 10 includes first parts 12A in corresponding parts except for parts to which the detent portions 26 are locked. The first parts 12A are parts formed along entire regions of respective side parts 22L on the outer periphery of the body 22 except for respective intermediate parts when viewed in a penetration direction of the attachment hole 12, so as to serve as parts that prevent rotation of the body 22 around its axis. Corners 12C of the edge portion of the attachment hole 12 of the door inner panel 10 are curved in an arc shape when viewed in the penetration direction of the attachment hole 12.

FIG. 3A is a bottom plan view of a part of the door inner panel 10 before the screw grommet 20 (see FIG. 3B) is assembled. As illustrated in FIG. 3A, second parts 12B are provided in the edge portion of the attachment hole 12 of the door inner panel 10 so as to correspond to the parts to which the detent portions 26 (see FIG. 3B) are locked. The second parts 12B are parts formed by cutting the edge portion toward opposite sides to a center-12Z side of the attachment hole 12 on the basis of respective extended lines 12X (see FIG. 3A) of the first parts 12A when viewed in the penetration direction of the attachment hole 12. Further, the second parts 12B are each provided between corresponding first parts 12A placed in line so as to be distanced from each other when viewed in the penetration direction of the attachment hole 12, and connect respective ends of the corresponding first parts 12A to each other in an arc shape. When viewed in the penetration direction of the attachment hole 12, respective circular arc centers of the second parts 12B correspond to a center 12Z (see FIG. 3A) of the attachment hole 12. In

FIG. 3A, a remaining part (a circular arc) of a circle including the circular arcs of the second parts 12B is indicated by an alternate long and two short dashes line K.

Note that right and left second parts 12B in FIG. 3B are provided so as to correspond to the parts to which the detent portions 26 are actually locked in an assembled state illustrated in FIG. 3B. Further, upper and lower second parts 12B in FIG. 3B are provided so as to correspond to parts to which the detent portions 26 are not locked in the assembled state illustrated in FIG. 3B, but the detent portions 26 are to be locked in other assembled states. That is, the upper and lower second parts 12B in FIG. 3B are provided so as to correspond to parts to which the detent portions 26 are to be locked in a case where the screw grommet 20 is assembled to the door inner panel 10 in such a manner that a relative position of the screw grommet 20 to the attachment hole 12 of the door inner panel 10, when viewed in an assembling direction, is shifted by 90° around its axis from a relative position illustrated in FIG. 3B.

Operations and effects of the above embodiment are described below.

The rectangular cylindrical body 22 of the screw grommet 20 illustrated in FIG. 1 is passed through the attachment hole 12 of the door inner panel 10 made of fiber reinforced resin. The detent portions 26 formed on the outer periphery side of the body 22 project toward the opposite sides to the axial center side of the body 22 and are displaceable toward the axial center side of the body 22 and the opposite sides thereto, so that the detent portions 26 are locked to the edge portion side of the attachment hole 12 of the door inner panel 10 as illustrated n FIG. 2B.

Here, as illustrated in FIG. 3B, the edge portion of the attachment hole 12 of the door inner panel 10 includes the first parts 12A at the parts except for the parts to which the detent portions 26 are locked. The first parts 12A are formed along corresponding parts of respective side parts 22L on the outer periphery of the body 22 when viewed in the penetration direction of the attachment hole 12, so as to prevent rotation of the body 22 around its axis. Particularly, in the present embodiment, the first parts 12A are formed along entire regions of respective side parts 22L on the outer periphery of the body 22 except for respective intermediate parts when viewed in the penetration direction of the attachment hole 12, thereby making it possible to effectively restrain wobbling of the screw grommet 20 by the first parts 12A.

Further, the second parts 12B are provided in the edge portion of the attachment hole 12 of the door inner panel 10 so as to correspond to the parts to which the detent portions 26 are locked. The second parts 12B are formed by cutting the edge portion toward the opposite sides to the center-12Z side of the attachment hole 12 on the basis of the extended lines 12X (see FIG. 3A) of the first parts 12A when viewed in the penetration direction of the attachment hole 12. On this account, at the time of assembling of the screw grommet 20 to the door inner panel 10, it is possible to restrain an insertion resistance caused at the time of forming an assembled state illustrated in FIG. 2B by inserting the body 22 of the screw grommet 20 into the attachment hole 12 of the door inner panel 10 as illustrated in FIG. 2A.

As described above, with the screw grommet attachment structure of the present embodiment, it is possible to restrain an insertion resistance at the time when the screw grommet 20 is inserted into the attachment hole 12, while restraining wobbling of the screw grommet 20. Further, in the present embodiment, the size of the attachment hole 12 is not increased uselessly, so water cut-off performance can be secured. Further, in the present embodiment, it is possible to apply an existing screw grommet to the screw grommet 20, so that it is possible to restrain a cost and achieve a high reliability in comparison with a case where a screw grommet is newly provided.

Further, in the present embodiment, as illustrated in FIG. 3A and FIG. 3B, the second parts 12B are each provided between corresponding first parts 12A placed in line so as to be distanced from each other when viewed in the penetration direction of the attachment hole 12, and connect respective ends of the corresponding first parts 12A to each other in an arc shape. As such, the second parts 12B are formed in an arc shape rather than a shape in which one side of a rectangular shape is removed, for example. Accordingly, it is possible to accurately form the second parts 12B in the door inner panel 10 made of fiber reinforced resin with the use of a drill, for example.

Note that the door trim 14 illustrated in FIG. 1 is fastened to a structure having the screw grommet attachment structure illustrated in FIG. 2B. This will be briefly described below. That is, after the door trim 14 is placed on the flange portion 24 of the screw grommet 20, the screw 18 penetrating through the screw insertion hole 16 of the door trim 14 is screwed into the screw hole 22H (see FIG. 2B) of the screw grommet 20, so that the door trim 14 is fastened to the door inner panel 10. Further, in a state where the screw 18 is fastened, the corners 22B of the screw grommet 20 swell out toward the opposite sides to the axial center side of the body 22, so that the screw grommet 20 is fixed to the door inner panel 10 firmly.

Note that, as a modification of the embodiment, an attachment hole other than the attachment hole 12 for door trim fastening, e.g., an attachment hole 30 for speaker fastening or an attachment hole 32 for ECU fastening in the door inner panel 10 as illustrated in FIG. 5, may be configured in a similar manner to the attachment hole 12 illustrated in FIG. 3, and the screw grommet 20 illustrated in FIG. 1 and the like may be inserted into such an attachment hole so as to be fastened thereto, for example.

Further, in the above embodiment, the body 22 of the screw grommet 20 is formed in a squarely cylindrical shape, but the body of the screw grommet may be formed in a rectangular cylindrical shape other than the squarely cylindrical shape, e.g., a hexagonal cylindrical shape or the like. Further, in the above embodiment, the body 22 of the screw grommet 20 is formed in a bottomed rectangular cylindrical shape, but the body of the screw grommet may be formed in a rectangular cylindrical shape without a bottom.

Further, in the above embodiment, the second parts 12B illustrated in FIG. 3A and FIG. 3B are set to have an arc shape, but the second parts may be set to shapes other than the arc shape, e.g., a shape in which one side of a rectangular shape is removed, a U-shape, and the like.

Further, as a modification of the embodiment, detent portions may be provided at corners on an outer periphery of a body having a rectangular cylindrical shape, when viewed in an axial direction of a screw grommet, first parts of an edge portion of an attachment hole of a panel member may be formed along respective intermediate parts (at least partially) of respective side parts on the outer periphery of the body when viewed in a penetration direction of the attachment hole, and further, second parts of the edge portion of the attachment hole of the panel member may be formed by cutting the edge portion toward opposite sides to a center side of the attachment hole on the basis of respective extended lines of the first parts (extended lines on corner sides) when viewed in the penetration direction of the attachment hole.

Further, as a modification of the embodiment, for example, such an arrangement may be employed that the pair of second parts 12B illustrated on the right and left sides in FIG. 3B are provided so as to correspond to the parts to which the detent portions 26 are actually locked in an assembled state illustrated in FIG. 3B, but the pair of second parts 12B illustrated on the upper and lower sides in FIG. 3B are not provided, and linear first parts (parts corresponding to the extended lines 12X of the first parts 12A on the upper and lower sides in FIG. 3A) are provided instead.

Note that the above embodiment and the plurality of modifications described above can be combined appropriately to perform the present disclosure.

One embodiment of the present disclosure has been described above, but the present disclosure is not limited to the above and may be modified in various ways to be performed as long as the modifications are not beyond the gist thereof

What is claimed is:

1. A screw grommet attachment structure comprising:
a screw grommet; and
a panel member made of fiber reinforced resin, wherein:
the screw grommet is attached to an attachment hole of the panel member;
the screw grommet includes a rectangular cylindrical body configured to be passed through the attachment hole of the panel member and having a screw hole into which a screw is screwed, the screw hole being formed in an axial center of the body;
the screw grommet includes a flange portion overhanging in a rib shape from one end of the body in an axis direction, the one end being on an inlet side of the screw hole, the flange portion being configured such that a circumferential part of the attachment hole of the panel member is placed on a surface side of the flange portion, the surface side being opposite to a surface around an inlet of the screw hole;
detent portions are formed on an outer periphery side of the body such that the detent portions project to opposite sides to an axial center side of the body and are displaceable toward the axial center side of the body and toward the opposite sides to the axial center side of the body, so that the detent portions are locked to an edge portion side of the attachment hole of the panel member;
an edge portion of the attachment hole of the panel member includes first parts formed at least partially along respective side parts on an outer periphery of the body except for parts to which the detent portions are locked, when viewed in a penetration direction of the attachment hole, the first parts being configured to prevent rotation of the body around an axis of the body; and
the edge portion of the attachment hole of the panel member includes second parts provided so as to correspond to the parts to which the detent portions are locked, the second parts being formed by cutting the edge portion toward opposite sides to a center side of the attachment hole on the basis of respective extended lines of the first parts when viewed in the penetration direction of the attachment hole.

2. The screw grommet attachment structure according to claim 1, wherein:
the detent portions are provided in respective intermediate parts of respective side parts on the outer periphery of the body when viewed in an axial direction of the screw grommet;
the first parts are formed along entire regions of the respective side parts on the outer periphery of the body except for the respective intermediate parts, when viewed in the penetration direction of the attachment hole; and
the second parts are each provided between corresponding first parts placed in line so as to be distanced from each other when viewed in the penetration direction of the attachment hole, and connect respective ends of the corresponding first parts to each other in an arc shape.
